(19) United States
(12) Patent Application Publication
(10) Pub. No.: US 2025/0087930 A1
(43) Pub. Date: Mar. 13, 2025

(54) HIGH SPEED RELIABLE RECEPTACLE ELECTRICAL CONNECTOR

(71) Applicant: Amphenol East Asia Electronic Technology (Shenzhen) Co., Ltd., Shenzhen (CN)

(72) Inventors: Kangqin Li, Shenzhen (CN); Zhimin Qin, Shenzhen (CN)

(73) Assignee: Amphenol East Asia Electronic Technology (Shenzhen) Co., Ltd., Shenzhen (CN)

(21) Appl. No.: 18/817,975

(22) Filed: Aug. 28, 2024

(30) Foreign Application Priority Data
Sep. 8, 2023 (CN) 202322442098.3

(51) Int. Cl. H01R 13/506; H01R 13/05; H01R 13/648

(52) U.S. Cl. CPC H01R 13/506; H01R 13/055; H01R 13/6485

(57) ABSTRACT

A high speed, reliable receptacle connector including a shell and a terminal subassembly disposed in the shell, with terminal mating ends extending to an opening of the shell and tail ends extending out of the shell. A component at least partially adjacent the top of the shell is configured to engage an exterior of a chassis of an electronic device when the connector is disposed inside the chassis with the opening of the shell aligned with a port of the chassis. A locating member is attached to the bottom wall of the shell. The locating member has a post extending downwardly and a projection extending upwardly into the shell to latch to the subassembly housing. The terminal subassembly has a shielding member disposed between two rows of terminals and having apertures disposed for reducing crosstalks and balancing impedance and easy manufacturing of the subassembly housing.

### CROSS-REFERENCE TO RELATED APPLICATION

This application claims priority to and the benefit of Chinese Patent Application Serial No. 202322442098.3, filed on Sep. 8, 2023, the contents of which are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB) and/or display communication port (DisplayPort), which are commonly used in computers. The standards have gone through multiple revisions, adapting to the higher performance expected from computers over time. For example, portable electronic devices often include receptacle connectors for various purposes such as charging and/or exchanging data with another electronic device by connecting the receptacle connector with a plug connector.

### BRIEF SUMMARY

Aspects of the present application relate to high speed reliable receptacle electrical connectors.

Some embodiments relate to a receptacle connector configured for use in an electronic device. The receptacle connector may comprise a shell comprising a top wall, bottom wall, first sidewall and second sidewall, bounding a cavity, an opening at a front and connected to the cavity, and a plurality of legs extending beyond the bottom wall; a terminal subassembly at least partially disposed in the cavity, the terminal subassembly comprising a subassembly housing and a plurality of conductive elements held by the subassembly housing, each of the plurality of conductive elements comprising a mating end extending toward the front of the shell, a tail end extending out of the bottom wall of the shell, and an intermediate portion between the mating end and the tail end; a locating member comprising a post extending parallel to the plurality of legs of the shell; and a component at least partially adjacent the top wall of the shell and configured to engage an exterior of a chassis of the electronic device.

Optionally, the component is a flange extending from the top wall of the shell; and the flange comprises a threaded hole such that the flange can be secured to the exterior of the chassis of the electronic device.

Optionally, the component is a frame comprising a top bar, a bottom bar, and an extension extending from the bottom bar and fixedly attached to the bottom wall of the shell; and the frame comprises an elastic portion extending from the top bar and configured for engaging the exterior of the chassis of the electronic device.

Optionally, the frame comprises an opening aligned with the opening of the shell; and first and second side bars each connecting the top bar and the bottom bar from respective sides and comprising a curved segment adjacent to the bottom bar.

Optionally, the elastic portion comprises a semi-cylindrical connecting portion extending from the top bar; and an overhanging arm extending from the semi-cylindrical connecting portion.

Optionally, the plurality of conductive elements of the terminal subassembly comprises a first plurality of conductive elements disposed in a first row, and a second plurality of conductive elements disposed in a second row; the terminal subassembly comprises a shielding member disposed between the first plurality of conductive elements and the second plurality of conductive elements and comprising a plurality of apertures; and the subassembly housing extends through apertures of the plurality of apertures.

Optionally, mounting surfaces of the tail ends of the first plurality of conductive elements and mounting surfaces of the tail ends of the second plurality of conductive elements are aligned in a same row.

Optionally, the first plurality of conductive elements comprises a plurality of signal terminals and a plurality of ground terminals; the mating ends of the plurality of ground terminals extend beyond the mating ends of the plurality of signal terminals; the intermediate portions of the plurality of signal terminals each comprises a narrow portion narrower than the respective mating end; and the intermediate portion of the plurality of ground terminals each comprises a wide portion wider than the respective mating end.

Optionally, the plurality of apertures of the shielding member comprises a first row of apertures disposed adjacent to a front end of the shielding member and below the mating ends of the plurality of signal terminals of the first plurality of conductive elements; a second row of apertures disposed adjacent to a rear end of the shielding member and below at least a portion of the wide portions of the plurality of ground terminals of the first plurality of conductive elements; and a third row of apertures disposed between the first row of apertures and the second row of apertures and below at least a portion of the narrow portions of the plurality of signal terminals of the first plurality of conductive elements.

Optionally, the locating member comprises a body attached to the bottom wall of the shell; and the post extends from the body downwardly.

Optionally, the locating member comprises a projection extending upwardly; and the projection of the locating member comprises a latch configured to engage a protrusion of the subassembly housing.

Some embodiments relate to an electronic system. The electronic system may comprise a chassis comprising a port; a circuit board disposed in the chassis; and a receptacle connector disposed in the chassis and mounted on the circuit board. The receptacle connector may comprise a shell comprising an opening aligned with the port of the chassis, and a plurality of legs connected to a ground plane of the circuit board, and a locating member comprising a post at least partially inserted into the circuit board.

Optionally, the receptacle connector comprises a component extending out of the port of the chassis to engage an exterior of the chassis.

Optionally, the shell of the receptacle connector comprises a top wall and a bottom wall; and the component is a flange extending from the top wall of the shell.

Optionally, the shell of the receptacle connector comprises a top wall and a bottom wall; and the component is a frame comprising a top bar disposed outside the chassis, a bottom bar, and an extension extending from the bottom bar and fixedly attached to the bottom wall of the shell of the receptacle connector, and an elastic portion extending from the top bar.

Optionally, the elastic portion comprises a semi-cylindrical connecting portion extending from the top bar; and an overhanging arm extending from the semi-cylindrical connecting portion and engaging the exterior of the chassis.

Optionally, the shell of the receptacle connector comprises a top wall and a bottom wall; and the locating member comprises a body attached to the bottom wall of the shell; and a projection extending into the shell of the receptacle connector and comprising a latch configured for engaging a connector housing.

Some embodiments relate to a method of manufacturing a receptacle connector. The method may comprise providing a terminal subassembly comprising a plurality of conductive elements held by a subassembly housing; disposing the terminal subassembly in a shell, with tail ends of the plurality of conductive elements extending out of the shell, the shell comprising a bottom wall and a plurality of legs extending beyond the bottom wall; and attaching a locating member to the bottom wall of the shell, the locating member comprising a post extending parallel to the plurality of legs of the shell.

Optionally, providing the terminal subassembly comprises molding over a first row of the plurality of conductive elements and a shielding member; disposing a second row of the plurality of conductive elements on the molded first row and shielding member; and molding over the first and second rows of conductive elements and the shielding member to form the subassembly housing.

Optionally, attaching the locating member to the bottom wall of the shell comprises inserting projections of the locating member into the shell to engage the subassembly housing of the terminal subassembly.

Some embodiments relate to an electrical connector. The electrical connector may comprise: a terminal subassembly comprising a plurality of conductive elements and a subassembly housing holding the plurality of conductive elements, each of the plurality of conductive elements comprising a mating end, a tail end provided opposite to the mating end, and an intermediate portion disposed between the mating end and the tail end and connecting the mating end with the tail end; an shell enclosing a cavity and sleeved on at least a portion of an outer side of the terminal subassembly; a locating member provided on at least a portion of an outer side of the shell and comprising a post, wherein the plurality of conductive elements comprises a first plurality of conductive elements and a second plurality of conductive elements, the first plurality of conductive elements and the second plurality of conductive elements are arranged in rows in a width direction of the electrical connector, respectively, and a mating end of an conductive element of the first plurality of conductive elements and a mating end of an conductive element of the second plurality of conductive elements are spaced apart from each other in a thickness direction of the electrical connector perpendicular to the width direction, and the terminal subassembly further comprises a shielding member disposed between the first plurality of conductive elements and the second plurality of conductive elements in the thickness direction.

Optionally, the mating end of the conductive element in the first plurality of conductive elements and the mating end of the conductive element in the second plurality of conductive elements are arranged in a staggered manner along the width direction, and the tail end of the conductive element in the first plurality of conductive elements and the tail end of the conductive element in the second plurality of conductive elements are arranged in a same plane perpendicular to the thickness direction of the electrical connector and are arranged in a row in a staggered manner along the width direction.

Optionally, each conductive element in the first plurality of conductive elements may comprise one first bending portion configured in such a way that the tail end of the conductive element in the first plurality of conductive elements extends towards the second plurality of conductive elements in the thickness direction, the first bending portions being arranged in a row and separated from each other in the width direction of the electrical connector; and each conductive element in the second plurality of conductive elements comprises a first bending portion and a second bending portion. The first bending portions and the second bending portions of the conductive elements in the second plurality of conductive elements are respectively arranged in rows parallel to each other in the width direction of the electrical connector, and each conductive element in the second plurality of conductive elements is configured, with the presence of the bending portion, such that the tail end of the conductive element in the second plurality of conductive elements extend, in a staggered manner, between the tail ends of adjacent conductive elements in the first plurality of conductive elements.

Optionally, the shielding member may be plate shaped, the shielding member is provided in the thickness direction between mating ends of the conductive elements of the first plurality of conductive elements and mating ends of the conductive elements of the second plurality of conductive elements, and a rear end of the shielding member is provided in a lengthwise direction perpendicular to the width direction to extend beyond the first bending portion of the second plurality of conductive elements and be spaced apart from the first bending portion of the first plurality of conductive elements.

Optionally, the conductive element in the first plurality of conductive elements and the conductive element in the second plurality of conductive elements may each comprise a plurality of signal terminals and a plurality of ground terminals, wherein, in a mating direction along which the electrical connector is engaged with a mating electrical connector, the mating ends of the ground terminals are arranged to extend beyond the mating end of the signal terminals.

Optionally, the plurality of signal terminals may comprise at least one signal terminal, the intermediate portion of the signal terminal comprising a narrow portion, the narrow portion having a first width in the width direction of the electrical connector, a mating end of the signal terminal having a second width in the width direction of the electrical connector, and the first width less than the second width.

Optionally, the plurality of ground terminals may comprise at least one ground terminal, the intermediate portion of the ground terminal comprising a wide portion, the wide portion having a third width in the width direction of the electrical connector, a mating end of the ground terminal having a fourth width in the width direction the electrical connector, and the third width greater than the fourth width.

Optionally, the wide portion of the ground terminal of the first plurality of conductive elements comprises the first bending portion, and the wide portion of the ground terminal of the second plurality of conductive elements comprises the first and second bending portions.

Optionally, the shielding member may comprise a plurality of apertures each having a substantially rectangle shape, and comprises at least three rows of apertures arranged parallel to each other in the width direction, the three rows of apertures comprising: a first row of apertures arranged adjacent to the front end of the shielding member in the lengthwise direction of the electrical connector; a second row of apertures arranged adjacent to the rear end of the shielding member in the lengthwise direction of the electrical connector; and a third row of apertures disposed between the first row of apertures and the second row of apertures.

Optionally, the first row of apertures may be provided in the thickness direction directly below mating ends of a plurality of signal terminals in the first plurality of conductive elements; and at least some apertures of the second row of apertures are provided in the thickness direction directly below at least a portion of the wide portion of a ground terminal in the first plurality of conductive elements; and at least other part of the apertures of the second row of apertures are provided in the thickness direction directly below at least a portion of the narrow portion of the signal terminal in the first plurality of conductive elements, wherein at least a portion of the subassembly housing is provided in a void formed among the first plurality of conductive elements, the plurality of apertures of the shielding member, and the second plurality of conductive elements.

Optionally, each aperture in the first row of apertures is formed to have a substantially rectangular shape, each aperture in the first row of apertures has a width greater than a width of a mating end of the plurality of signal terminals, and a mating inner edge of each aperture in the first row of apertures is arranged in the lengthwise direction to be closer to a mating peripheral portion of the shell than the mating end of the plurality of signal terminals.

Optionally, the shell may comprise a top wall and a bottom wall opposite to the top wall in a thickness direction; a first sidewall; and a second sidewall opposite to the first sidewall in a width direction. The top wall may be provided with a flange extending from a mating edge of the top wall in the thickness direction towards an outer side of the electrical connector, the flange being provided with a threaded hole.

Optionally, the bottom wall may comprise an opening through which at least a portion of the subassembly housing and the tail end of the plurality of conductive elements are exposed, the locating member comprises a board-shaped body portion arranged to extend over at least a portion of an outer surface of the bottom wall of the shell and a portion of the subassembly housing exposed by the opening, and the board-shaped body may comprise a first side facing towards the bottom wall, and a second side opposite to the first side and provided with a post, the post extending from the second side of the locating member towards the outer side of the electrical connector and being formed integrally with the locating member. The locating member further comprises a plurality of projections extending from the first side towards the inner side of the shell, the projections extending into the subassembly housing via the opening of the bottom wall, so as to be secured in place in the subassembly housing.

Optionally, the plurality of projections may comprise a first projection and a second projection extending in a manner parallel to each other in the thickness direction towards the subassembly housing and provided on the opposite sides of the locating member in the width direction, and the post is arranged at a substantially central position of the locating member in the width direction.

Optionally, the first projection and the second projection are each formed as an elongated cantilever beam, which has a free end provided with a latch, and the subassembly housing comprises a protrusion mating with the latch in a snap-fit manner.

Optionally, the latch comprises a protrusion protruding from the free end of the elongated cantilever beam towards the first sidewall or the second sidewall, and the protrusion comprises a concave accommodating part which is mated with the protrusion.

Optionally, a plurality of beams may be provided in at least one of the top wall, the bottom wall, the first sidewall and the second sidewall.

Optionally, the beam may extend along a lengthwise direction of the shell perpendicular to both the width direction and the thickness direction, the beam may comprise a first angled portion, a second angled portion and an curved portion disposed between the first angled portion and the second angled portion and connecting the first angled portion with the second angled portion, the first angled portion and the second angled portion are each tilted inwardly with respect to the outer surface of the shell and the curved portion protrudes towards an inner side of the shell.

Optionally, the plurality of beams may comprise a first row of beams provided in the top wall and a second row of beams provided in the bottom wall, and the first row of beams and the second row of beams are symmetrical with respect to a plan that runs through a horizontal central axis along the width direction.

Optionally, the electrical connector may comprise a spring shell having an opening, and an inner circumferential edge of the opening is arranged at an outer side of the shell of the electrical connector in a projection plane of the electrical connector perpendicular to the lengthwise direction, the spring shell comprising an extension fixedly connected with the bottom wall of the shell and extending parallel to the bottom wall of the shell, and an elastic portion arranged adjacent to the top of the top wall of the electrical connector.

Optionally, the spring shell may comprise a frame comprising a top bar and a bottom bar opposite to each other and a first side bar and a second side bar opposite to each other, the top bar and the bottom bar are arranged on the opposite sides of the shell in the thickness direction, the first side bar and the second side bar each comprise a curved segment and are arranged on the opposite sides of the shell in the width direction, the elastic portion is provided on the top bar and the extension is provided on the bottom bar.

These techniques may be used alone or in any suitable combination. The foregoing summaries are provided by way of illustration and are not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, front perspective view of an electrical connector, according to some embodiments;

FIG. 2 is a partially exploded perspective view of the electrical connector of FIG. 1;

FIG. 3 is a perspective view of a terminal subassembly of the electrical connector of FIG. 1, with a subassembly housing hidden, showing a first plurality of conductive elements, a second plurality of conductive elements, and a shielding member;

FIG. 4 is a perspective exploded view of the terminal subassembly of FIG. 3;

FIG. 5 and FIG. 6 are perspective views of the first plurality of conductive elements of the terminal subassembly of FIG. 3;

FIG. 7 and FIG. 8 are perspective views of the second plurality of conductive elements of the terminal subassembly of FIG. 3;

FIG. 9 is a perspective view of the shielding member of the terminal subassembly of FIG. 3;

FIG. 10 is a perspective view of the terminal subassembly of FIG. 3, showing the shielding member and the first plurality of conductive elements, with the second plurality of conductive elements hidden;

FIG. 11 is a bottom, rear perspective view of the electrical connector of FIG. 1, showing a shell, with the locating member hidden;

FIG. 12 is a bottom, rear perspective view of the electrical connector of FIG. 1, showing the locating member attached to the shell;

FIG. 13 is a bottom view of the electrical connector of FIG. 1, with the shell hidden, showing the terminal subassembly and the locating member;

FIG. 14 is cross-section view of the electrical connector of FIG. 1, taken along a line marked “A-A” in FIG. 13;

FIG. 15 is a perspective view of the second plurality of conductive elements and the shielding member of the terminal subassembly of FIG. 3 held by a first insulative member formed by a first injection molding, according to an exemplary method of manufacturing the electrical connector of FIG. 1;

FIG. 16 is a perspective view of the first and second plurality of conductive elements and the shielding member of the terminal subassembly of FIG. 3 held by a second insulative member formed by a second injection molding, according to an exemplary method of manufacturing the electrical connector of FIG. 1;

FIG. 17 is a top, side perspective view of an electrical connector, according to some embodiments;

FIG. 18 is a partially exploded perspective view of the electrical connector of FIG. 17;

FIG. 19 is a rear, bottom perspective view of the electrical connector of FIG. 17;

FIG. 20 is a side view of an electronic system, showing the electrical connector of FIG. 17, a chassis, and a printed circuit board, according to some embodiments; and

FIG. 21 is a perspective view of a spring shell of the electrical connector of FIG. 17.

### DETAILED DESCRIPTION

The inventors have recognized and appreciated techniques for making high speed reliable receptacle electrical connectors. A receptacle connector may be integrated inside a chassis of an electronic device and configured to receive a mating component such as a plug connector to enable the electronic device to connect with other devices. Conventional designs may have complexed structures, which can complicate the manufacturing process. For example, conventional designs may include a positioning post that is integrally formed with the connector housing. However, this approach can present challenges in the molding process. Additionally, conventional designs may not satisfy the increasing demands for higher transmission speeds.

Techniques described herein enable high speed, reliable receptacle connectors while reducing both manufacturing complexity and cost. Such techniques are illustrated herein as applied to a DisplayPort right-angle receptacle connector.

According to aspects of the present disclosure, a connector may include a shell, a terminal subassembly disposed in the shell, with terminal mating ends extending to an opening of the shell and tail ends extending out of the shell. A component at partially adjacent the top of the shell may be configured to engage an exterior of a chassis of an electronic device when the connector is disposed inside the chassis with the opening of the shell aligned with a port of the chassis. A locating member may be attached to the bottom wall of the shell. The locating member may have a post extending downwardly for inserting into a circuit board on which the connector can be mounted. The shell may have legs extending downwardly and configured to connect to a ground plane of the circuit board. The locating member may have a projection extending upwardly into the shell to latch to the subassembly housing.

In some embodiments, the terminal subassembly may have first and second plurality of conductive elements disposed in first and second rows, respectively. The terminal subassembly may include a shielding member disposed between the two rows of conductive elements and having apertures disposed for reducing crosstalks and balancing impedance and easy manufacturing of the subassembly housing. By providing a shielding member between the first plurality of conductive elements and the second plurality of conductive elements, the overall structural strength of the terminal subassembly can be improved, and electromagnetic interference signals emitted by the conductive elements of one of the first plurality of conductive elements and the second plurality of conductive elements can be efficiently shielded with respect to the other one of the first plurality of conductive elements and the second plurality of conductive elements.

According to aspects of the present disclosure, the relative position and arrangement of the first plurality of conductive elements and the second plurality of conductive elements may comply with the display port standard, structural compactness is achieved while meeting the requirements for multimedia signal transmission.

In some embodiments, the conductive elements in the first and second rows may have corresponding bending portions, such that the tail end of the conductive element of the second plurality of conductive elements and the tail end of the conductive element of the second plurality of conductive elements can be arranged in a row in a staggered manner, thereby enabling a more compact arrangement of the tail ends of the conductive elements and reducing the space occupied by the tail ends. The structural compactness and stability of the terminal subassembly can be improved can be improved with this arrangement.

In some embodiments, in a mating direction along which the electrical connector is engaged with a mating electrical connector, the mating ends of the ground terminals of the electrical connector may be arranged to extend beyond the mating ends of the signal terminals.

For example, the ground terminal may be longer than the signal terminal, and when the electrical connector is mated with a mating electrical connector, the ground terminal of the electrical connector will be firstly in contact/engagement with the ground terminal of the mating electrical connector, thus ensuring the hot plugging and unplugging performance (Hot Swap performance) of the electrical connector.

In some embodiments, the intermediate portions of the signal terminals may be provided with a narrow portion, e.g., the signal terminals have varying widths along their length, so as to modify the impedance of the signal terminal. The impedance of a terminal is usually inversely proportional to the width of the terminal itself, the impedance of the terminal at the narrowing section is increased. Accordingly, the provision of the narrow portion of the signal terminal facilitates the adjustment of the impedance of the signal terminal itself to meet the impedance requirements.

In some embodiments, the ground terminal may comprise a wide portion, which can improve the mechanical strength of the ground terminal while improving the shielding performance of the ground terminal. In addition, the ground terminal can have varying widths along their length, which can impact the impedance of the adjacent signal terminals due to closer distance to a ground.

In some embodiments, the first row of apertures may be provided in the thickness direction directly below mating ends of a plurality of signal terminals of the first plurality of conductive elements. During injection molding, the first row of apertures may be filled by dielectric material and the mating ends of the signal terminals of the first plurality of conductive elements and the mating ends of the signal terminals of the second plurality of conductive elements can be encapsulated.

In some embodiments, the first row of apertures can be provided in the thickness direction directly below the mating ends of the plurality of signal terminals of the first plurality of conductive elements, and at least other part of the aperture in the second row of apertures can be provided in the thickness direction directly below at least a portion of the narrow portion of the signal terminal of the first plurality of conductive elements, and in the process of injection molding, the dielectric material can fill the void formed among the first plurality of conductive elements, the plurality of apertures of the shielding member, and the second plurality of conductive elements, and support the individual conductive elements in the first plurality of conductive elements and the second plurality of conductive elements.

In some embodiments, by providing a flange having a threaded hole on the top wall of the shell, the flange can be securely connected to the exterior of the chassis by a threaded connection, thereby facilitating rapid assembly and disassembly of the electrical connector and the printed circuit board.

In some embodiments, the locating member having a post can be mounted into the subassembly housing of the electrical connector and secured in place by, e.g., a projection. The locating member may have features that form a snap-fit engagement to other components of the connector.

In some embodiments, when the electrical connector is mounted to the chassis of the electronic device, the elastic portions of the spring shell can be pressed to abut against the exterior of the chassis of the electronic device and elastically deformed so that the spring shell is electrically connected to the chassis of the electronic device. When the chassis of the electronic device is made of metal, static electricity generated in the chassis of the electronic device can be conducted through the spring shell, through the shell of the electrical connector, and then to the ground portion of the printed circuit board which is connected to the leg of the shell, so as to quickly and efficiently direct the static electricity generated in the chassis of the electronic device to the ground portion of the printed circuit board, to prevent electrostatic discharge hazards and ensure operational safety.

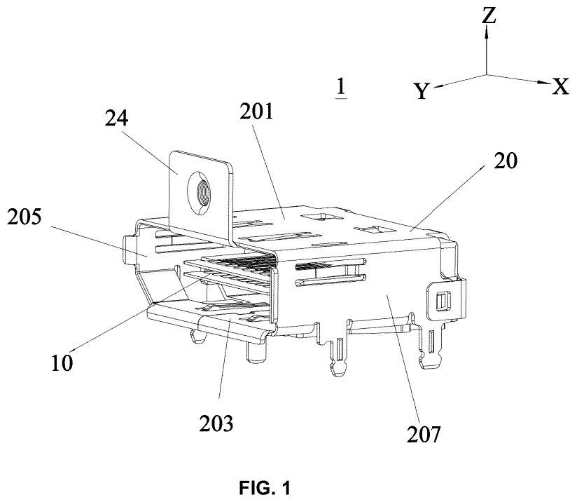

As shown in FIGS. 1-4, the electrical connector 1 may comprise a terminal subassembly 10. The terminal subassembly 10 may include a plurality of conductive elements 110 and a subassembly housing 120 holding the plurality of conductive elements 110. Each of the plurality of conductive elements 110 may have a shape of an elongated strip. Each of the plurality of conductive elements 110 may include a mating end 111, a tail end 113 opposite to the mating end 111, and an intermediate portion 112 disposed between the mating end 111 and the tail end 113 and connecting the mating end 111 with the tail end 113. A shell 20 may enclose a cavity and may be sleeved on at least a portion of an outer side of the terminal subassembly 10. A locating member 30 may be provided on at least a portion of an outer side of the shell 20 and comprise a post 301.

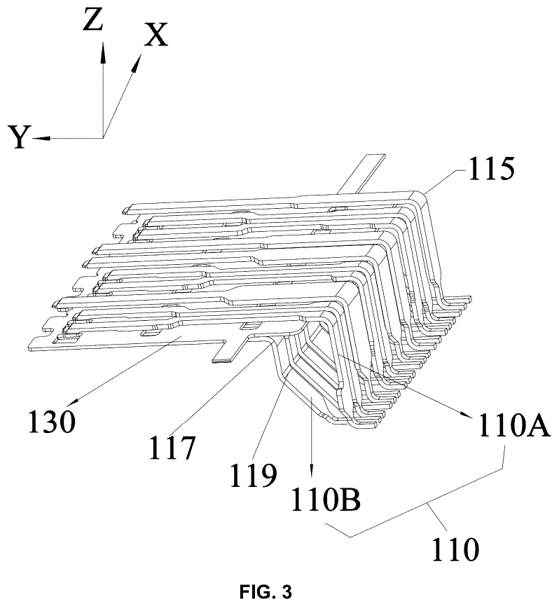

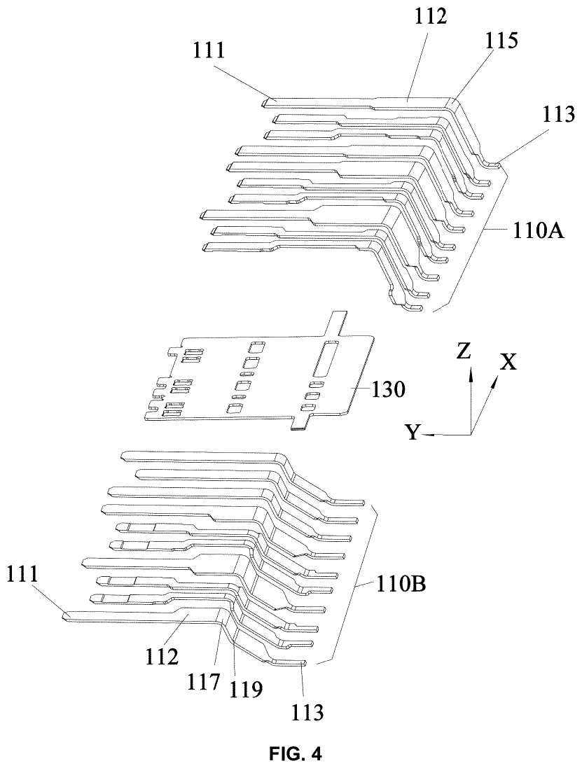

As shown in FIG. 3 and FIG. 4, the plurality of conductive elements 110 comprises a first plurality of conductive elements 110A and a second plurality of conductive elements 110B. The first plurality of conductive elements 110A and the second plurality of conductive elements 110B are arranged in rows in a width direction X of the electrical connector 1, respectively. The mating ends of the conductive elements of the first plurality of conductive elements 110A and the mating ends of the conductive elements of the second plurality of conductive elements 110B are spaced apart from each other in a thickness direction Z of the electrical connector 1 perpendicular to the width direction X. The terminal subassembly 10 further comprises a shielding member 130 disposed between the first plurality of conductive elements 110A and the second plurality of conductive elements 110B in the thickness direction Z.

With the electrical connector 1 according to an exemplary embodiment of the present application, by providing a shielding member 130 between the first plurality of conductive elements 110A and the second plurality of conductive elements 110B, the signal crosstalk between the first plurality of conductive elements 110A and the second plurality of conductive elements 110B can be efficiently shielded to achieve a faster data transmission speed. In some embodiments, the electrical connector 1 is capable of supporting data transfer speeds of up to 40 Gbps and 80 Gbps.

The shell 20 may be made of conductive materials (e.g., iron, aluminum, and alloys thereof). Optionally, the shell 20 may be made of cast iron. In some embodiments, the shielding member 130 may be made of a conductive material, such as an iron-carbon alloy. In some embodiments, the shielding member 130 may be formed by stamping a metal sheet.

In the embodiments shown in FIG. 3 and FIG. 4, the mating end of the conductive element in the first plurality of conductive elements 110A and the mating end of the conductive element in the second plurality of conductive elements 110B are spaced apart from each other in the thickness direction Z of the electrical connector 1, and arranged in a staggered manner in the width direction X. The tail ends of the conductive elements in the first plurality of conductive elements 110A and the tail ends of the conductive elements in the second plurality of conductive elements 110B are arranged in a same plane perpendicular to the thickness direction Z of the electrical connector 1 and are staggered with each other in a row in the width direction X, as shown in FIG. 3.

According to an embodiment of the present application, the conductive elements in the first plurality of conductive elements 110A and the conductive elements in the second plurality of conductive elements 110B each can be subjected to a bending process, such that the mating ends of the conductive elements in the first plurality of conductive elements 110A and the mating ends of the conductive elements in the second plurality of conductive elements 110B are spaced apart from each other in the thickness direction Z of the electrical connector 1, and the tail ends of the conductive elements in the first plurality of conductive elements 110A and the tail ends of the conductive elements in the second plurality of conductive elements 110B are arranged in a same plane perpendicular to the thickness direction Z of the electrical connector 1.

As shown in FIG. 3 and FIG. 4, each conductive element in the first plurality of conductive elements 110A may comprise one first bending portion 115 configured in such a way that the tail end of the conductive element in the first plurality of conductive elements 110A extends towards the second plurality of conductive elements 110B in the thickness direction Z. The first bending portion 115 is arranged in a row and separated from each other in the width direction X of the electrical connector 1.

In some embodiments, each conductive element in the second plurality of conductive elements 110B may comprise a first bending portion 117 and a second bending portion 119. The first bending portions 117 and the second bending portions 119 of the conductive elements in the second plurality of conductive elements 110B are arranged in rows parallel to each other in the width direction X of the electrical connector 1, and each conductive element in the second plurality of conductive elements 110B is configured, with the presence of the second bending portion 119, such that the tail end of the conductive element in the second plurality of conductive elements 110B extend, in a staggered manner, between the tail ends of adjacent conductive elements in the first plurality of conductive elements 110A.

In some embodiments, each conductive element in the first plurality of conductive elements 110A may be configured to comprise one or more first bending portions, and each conductive element in the second plurality of conductive elements 110B may be configured to comprise one or more second bending portions. The corresponding bending angles of the first bending portion and the second bending portion may not be limited to the angles of the illustrated embodiment.

As shown in FIG. 3 and FIG. 4, the shielding member 130 may be plate shaped. The shielding member 130 may be provided in the thickness direction Z between the mating ends of the conductive elements of the first plurality of conductive elements 110A and the mating ends of the conductive elements of the second plurality of conductive elements 110B. A rear end of the shielding member 130 may be provided in a lengthwise direction Y of the electrical connector 1 perpendicular to the width direction X to extend beyond the first bending portion 117 of the second plurality of conductive elements 110B and be spaced apart from the first bending portion 115 of the first plurality of conductive elements 110A.

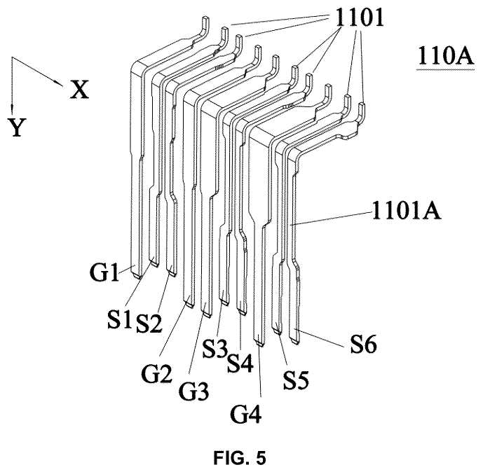

As shown in FIGS. 5-8, the conductive elements in the first plurality of conductive elements 110A and the conductive elements in the second plurality of conductive elements 110B respectively comprise a plurality of signal terminals S1 to S11 and a plurality of ground terminals G1 to G9. The mating ends of the ground terminals G1 to G9 are arranged to extend beyond the mating end of the signal terminals S1 to S11 in a mating direction along which the electrical connector is engaged with a mating electrical connector.

With the electrical connector according to an exemplary embodiment of the present application, in a mating direction (for example, the lengthwise direction Y of the electrical connector 1 as shown in FIG. 5) of the electrical connector 1 engaged with a mating electrical connector, the mating ends of the ground terminals G1 to G9 of the conductive element comprised in the first plurality of conductive elements 110A and the conductive element comprised in the second plurality of conductive elements 110B are arranged to extend beyond the mating ends of the signal terminals S1 to S11. For example, the ground terminals G1 to G9 are longer than the signal terminals S1 to S11, and when the electrical connector 1 is mated with a mating electrical connector, the ground terminals G1 to G9 of the electrical connector 1 will firstly be in contact/engagement with the ground terminals of a mating electrical connector, thus ensuring the hot plugging and unplugging performance (Hot Swap performance) of the electrical connector.

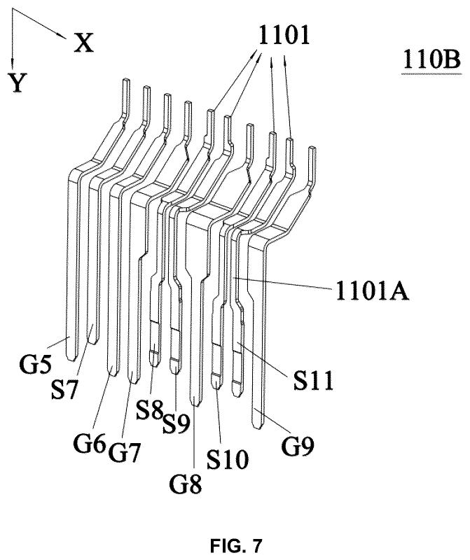

As shown in FIG. 5 and FIG. 7, the plurality of signal terminals S1 to S11 comprise at least one signal terminal 1101, the intermediate portion of the signal terminal 1101 comprises a narrow portion 1101A. The narrow portion 1101A has a first width in the width direction X of the electrical connector, a mating end of the signal terminal 1101 has a second width in the width direction X of the electrical connector, and the first width is smaller than the second width. In some embodiments, individual signal terminals of the signal terminals 1101 may include narrow portions having varying widths along its length.

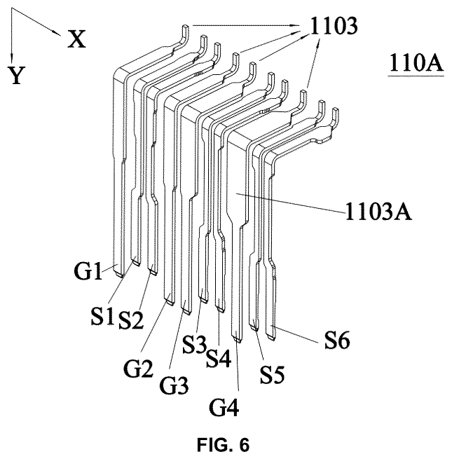

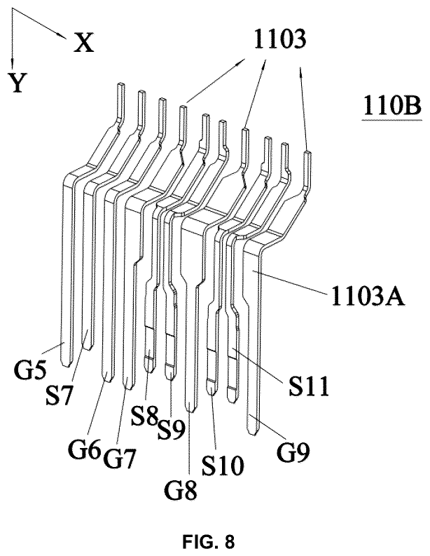

As shown in FIG. 6 and FIG. 8, the plurality of ground terminals G1 to G9 comprise at least one ground terminal 1103, the intermediate portion of the ground terminal 1103 comprises a wide portion 1103A. The wide portion 1103A has a third width in the width direction X of the electrical connector, a mating end of the ground terminal 1103 has a fourth width in the width direction X of the electrical connector, and the third width is greater than the fourth width. In some embodiments, individual ground terminal of the at least one ground terminal 1103 may include wide portions having varying widths along its length.

In some embodiments, as shown in FIGS. 5-8, the first plurality of conductive elements 110A and the second plurality of conductive elements 110B each are provided with ten conductive elements. As shown in FIG. 5 and FIG. 6, the first plurality of conductive elements 110A includes six signal terminals S1, S2, S3, S4, S5, S6 and four ground terminals G1, G2, G3, G4. The signal terminals S1, S2, S3, S4, S5, S6 are all configured as a signal terminal 1101 having a narrow portion 1101A. The ground terminals G3, G4 are each configured as a ground terminal 1103 having a wide portion 1103A.

Further, as shown in FIG. 7 and FIG. 8, the second plurality of conductive elements 110B includes five signal terminals S7, S8, S9, S10, S11 and five ground terminals G5, G6, G7, G8, G9. The signal terminals S7, S8, S9, S10, S11 are all configured as a signal terminal 1101 having a narrow portion 1101A. The ground terminals G7, G8, G9 are all configured as a ground terminal 1103 having a wide portion 1103A.

In some embodiments, a pair of signal terminals arranged between the two adjacent ground terminals may be configured to transmit a pair of differential signals. For example, the pair of signal terminals S1, S2 arranged between the two adjacent ground terminals G1 and G2 may be configured to transmit a pair of differential signals. One signal terminal arranged between two adjacent ground terminals can be configured to transmit a single-ended signal. For example, one signal terminal S7 arranged between the two adjacent ground terminals G5 and G6 may be configured to transmit a single-ended signal.

In some embodiments, a first width of the narrow portion 1101A of the signal terminal 1101 may be in the range of 0.10 mm to 0.60 mm, and a second width of the mating end of the signal terminal 1101 may be in the range of 0.20 mm to 0.70 mm. Further, the wide portion 1103A of the ground terminal 1103 may be in the range of 0.30 mm to 0.80 mm, and the fourth width of the mating end of the ground terminal 1103 may be in the range of 0.20 mm to 0.70 mm. In some embodiments, the size, shape, and arrangement of the mating end of the signal terminal and the mating end of the ground terminal may not be limited to the above exemplary descriptions, but may be set as required to meet an industry standard for a display communication port (referred to as DP for short). In some examples, the width of the mating end of the signal terminal and the mating end of the ground terminal may be provided to be the same.

With the electrical connector according to an exemplary embodiment of the present application, the signal terminal 1101 among the signal terminals S1 to S11 comprises a narrow portion 1101A, and the signal terminal 1101 is provided to have a varying width along its length, so as to allow the impedance of the signal terminal 1101 itself to change. The impedance of a terminal is usually inversely proportional to the width of the terminal itself, and thus the impedance of the terminal at the narrowing section 1101A increases. The provision of the narrow portion may facilitate the adjustment of the impedance of the signal terminal itself to meet the impedance requirements.

The ground terminal 1103 comprises a wide portion 1103A, and the wide portion 1103A improves the mechanical strength of the ground terminal 1103 while improving the shielding performance of the ground terminal 1103. The ground terminal 1103 is provided to have a varying width along its length, which can impact the impedance of the adjacent signal terminals due to closer distance to a ground.

In some embodiments, the position of the narrow portion 1101A of the signal terminal 1101 along its length is provided to at least partially correspond to the position of the wide portion 1103A of the ground terminal 1103.

In some embodiments, the wide portion 1103A of the ground terminal 1103 of the first plurality of conductive elements 110A may comprise the first bending portion 115, and the wide portion 1103A of the ground terminal 1103 of the second plurality of conductive elements 110B may comprise the first and second bending portions 117, 119. With this configuration, mechanical strength and structural stability of the ground terminal 1103 are ensured.

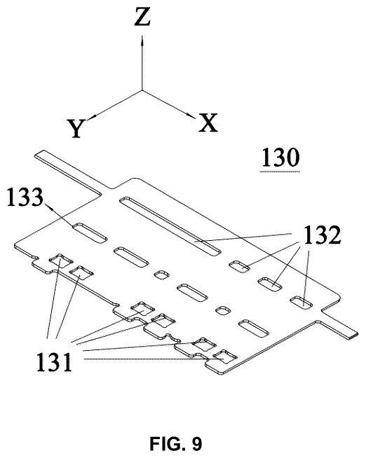

In some embodiments, as shown in FIG. 9, the shielding member 130 may comprise a plurality of apertures each having a substantially rectangle shape. The shielding member 130 may comprise at least three rows of apertures arranged parallel to each other in the width direction X. The three rows of apertures may comprise a first row of apertures 131 arranged in the lengthwise direction Y of the electrical connector adjacent to the front end of the shielding member 130; a second row of apertures 132 arranged in the lengthwise direction Y of the electrical connector 1 adjacent to the rear end of the shielding member; and a third row of apertures 133 disposed between the first row of apertures 131 and the second row of apertures 132. In some embodiments, the number, size, and arrangement of the plurality of apertures in the shielding member 130 may not be limited to the exemplary embodiments described herein, and may be modified as necessary to meet specific requirements.

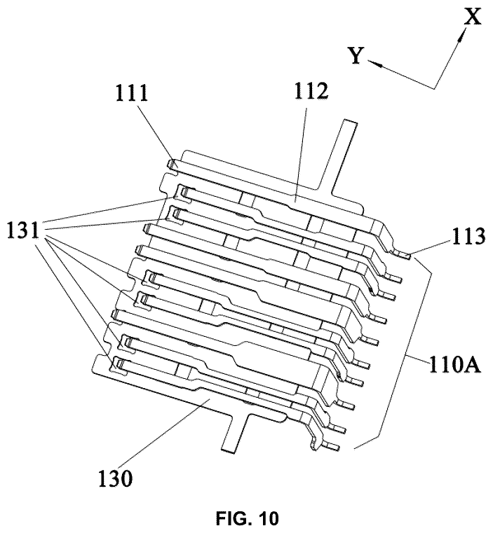

In some embodiments, as shown in FIG. 10, the first row of apertures 131 is provided in the thickness direction Z directly below the mating ends of a plurality of signal terminals S1, S2, S3, S4, S5, S6 in the first plurality of conductive elements 110A.

In the illustrated embodiment, at least a part of the apertures of the second row of apertures 132 is provided in the thickness direction Z directly below at least a portion of the wide portion 1103A of a ground terminal 1103 in the first plurality of conductive elements 110A; and at least other part of the apertures of the second row of apertures 132 are provided in the thickness direction Z directly below at least a portion of the narrow portion 1101A of the signal terminal 1101 in the first plurality of conductive elements 110A.

According to an embodiment of the present application, at least a portion of the subassembly housing 120 of the terminal subassembly 10 may be provided in a void formed among the first plurality of conductive elements 110A, the plurality of apertures of the shielding member 130, and the second plurality of conductive elements 110B.

According to an exemplary method of manufacturing the electrical connector, during injection molding, the first row of apertures 131 is filled by dielectric material and the mating ends of the signal terminals of the first plurality of conductive elements 110A and the mating ends of the signal terminals of the second plurality of conductive elements 110B are encapsulated.

In some embodiments, as shown in FIG. 10, each aperture in the first row of apertures 131 may be formed to have a substantially rectangular shape. Each aperture in the first row of apertures 131 has a width greater than a width of a mating end of the plurality of signal terminals, and a mating inner edge of each aperture in the first row of apertures 131 is arranged in the lengthwise direction Y to be closer to a mating peripheral portion of the shell 20 than the mating end of the plurality of signal terminals.

In some embodiments, as shown in FIG. 1, the shell 20 comprises a top wall 201, and a bottom wall 203 opposite to the top wall 201 in the thickness direction Z. The top wall 201 may include a flange 24 extending from a mating edge of the top wall 201 in the thickness direction Z towards an outer side of the electrical connector. The flange 24 may include a threaded hole. The flange can be securely connected to the exterior of the chassis of the electronic device by a threaded connection, thereby facilitating quick assembly and disassembly of the electrical connector and the electronic device.

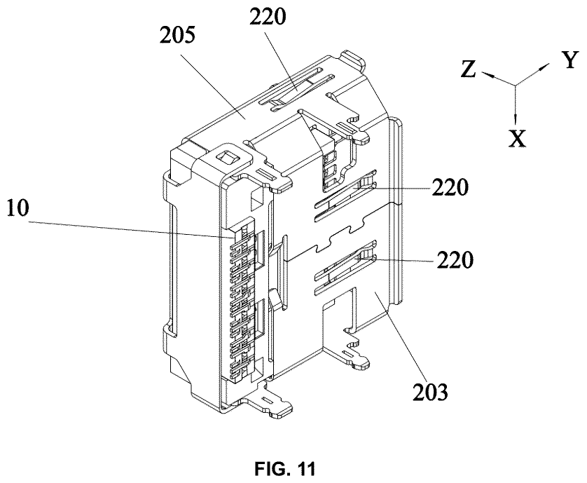

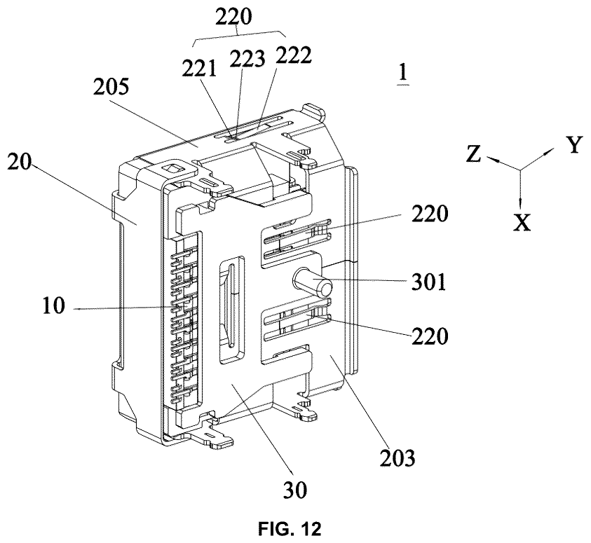

In some embodiments, as shown in FIG. 11 and FIG. 12, FIG. 11 illustrates a perspective view of the electrical connector 1, with the locating member 30 hidden, and FIG. 12 illustrates a perspective view of the electrical connector 1, showing the locating member 30.

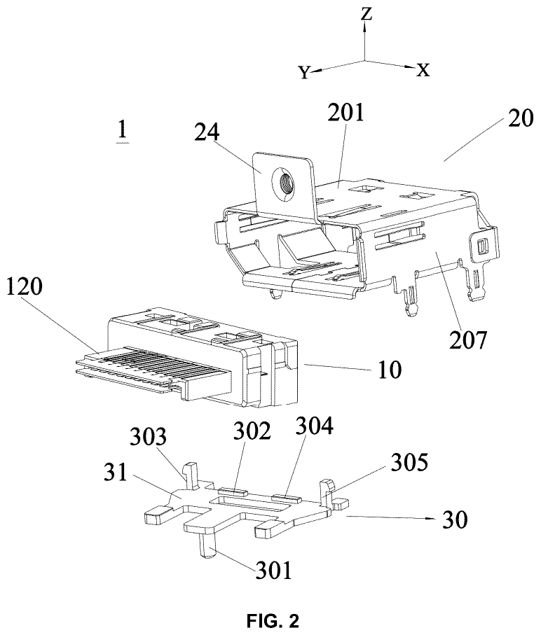

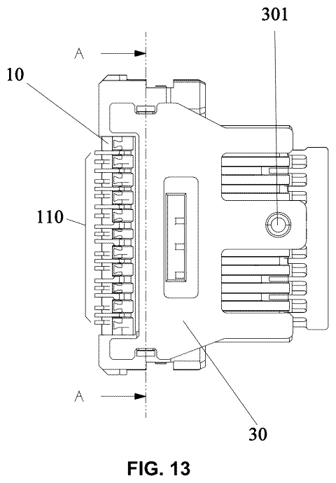

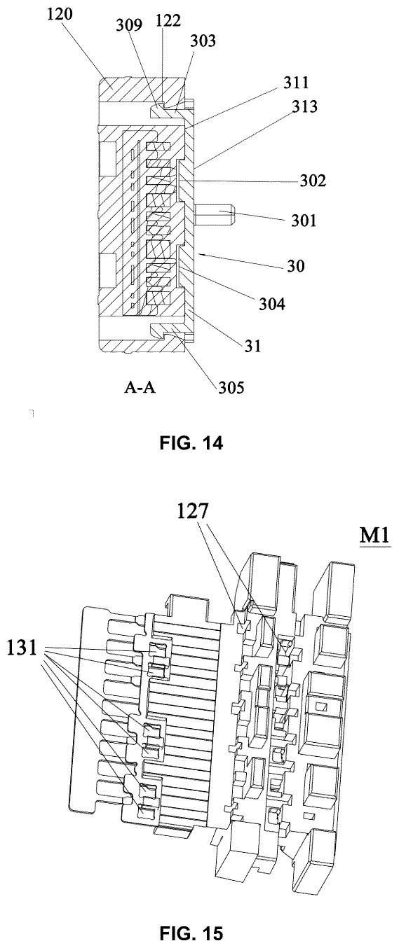

In the illustrated embodiment, the bottom wall 203 comprises an opening through which at least a portion of the subassembly housing 120 and the tail end of the plurality of conductive elements 110 are exposed. The locating member 30 comprises a board-shaped body 31 arranged to extend over at least a portion of an outer surface of the bottom wall 203 of the shell 20 and a portion of the subassembly housing 120 exposed by the opening. As shown in FIG. 2, FIG. 13 and FIG. 14, the board-shaped body 31 comprises a first side 311 facing towards the bottom wall 203, and a second side 313 opposite to the first side 311 and provided with the post 301. The post 301 extends from the second side 313 of the locating member 30 towards the outer side of the electrical connector and is formed integrally with the locating member 30. The locating member 30 further comprises a plurality of projections extending from the first side 311 towards the inner side of the shell 20, and the projections extend into the subassembly housing 120 via the openings of the bottom wall 203, so as to be secured in place in the subassembly housing 120.

In some embodiments, the plurality of projections of the locating member 30 comprise a first projection 303 and a second projection 305 extending in a manner parallel to each other in the thickness direction Z towards the subassembly housing 120 and provided on the opposite sides of the locating member 30 in the width direction X, and the post 301 is arranged at a substantially central position of the locating member 30 in the width direction X.

In some embodiments, as shown in FIG. 13 and FIG. 14, the first projection 303 and the second projection 305 are each formed as an elongated cantilever beam having a free end provided with a latch 309. The subassembly housing 120 comprises a protrusion 122 configured to engage with the latch 309 in a mating manner to realize latching.

The locating member 30 having the post 301 can be mounted into the subassembly housing of the electrical connector and secured in place with the aid of the projections. Since the locating member 30 is independently fabricated and subsequently fitted into the subassembly housing 120 of the terminal subassembly 10, the manufacturing process of the electrical connector is simplified and the molding complexity is reduced.

As shown in FIG. 1 and FIG. 2, In some embodiments, the shell 20 may be configured to comprise a first sidewall 205 and a second sidewall 207 opposite to the first sidewall 205 in the width direction X. In some embodiments according to the present application, the latch 309 may comprise a protrusion protruding from the free end of the elongated cantilever beam of the locating member 30 towards the first sidewall 205 or the second sidewall 207, and the protrusion 122 of the subassembly housing 120 may comprise a concave accommodating part which is mated with the protrusion in a snap-fit manner.

In some embodiments, as shown in FIG. 13 and FIG. 14, the locating member 30 further comprises a plurality of positioning projections 302, 304 provided on the first side 311, and the outer surface of the subassembly housing 120 comprises corresponding recesses which are mated with the plurality of positioning projections 302, 304. In some examples, the positioning projections 302, 304 are formed to have a rectangular shape. The provision of the positioning projections 302, 304 and corresponding recesses, which are mutually mated, on the locating member and the subassembly housing may ensure a precise positioning of the locating member 30 with respect to the subassembly housing 120 and thus a precise positioning of the locating member 30 with respect to the terminal subassembly 10.

In some embodiments, as shown in FIG. 1, FIG. 11, and FIG. 12, a plurality of beams 220 are provided in at least one of the top wall 201, the bottom wall 203, the first sidewall 205 and the second sidewall 207.

In some embodiments, the beam 220 extends along a lengthwise direction Y of the shell 20 perpendicular to both the width direction X and the thickness direction Z. The beam 220 comprises a first angled portion 221, a second angled portion 222 and a curved portion 223 (as shown in FIG. 12) disposed between the first angled portion 221 and the second angled portion 222 and connecting the first angled portion 221 with the second angled portion 222. The first angled portion 221 and the second angled portion 222 are each tilted inwardly with respect to the outer surface of the shell 20 and the curved portion 223 protrudes towards an inner side of the shell 20.

In some embodiments, the plurality of beams 220 comprise a first row of beams provided in the top wall 201 and a second row of beams provided in the bottom wall 203. The first row of beams and the second row of beams may be symmetrical with respect to a plan that runs through a horizontal central axis along the width direction. In some embodiments, the number, size, and arrangement of the beams 220 may not be limited to the exemplary embodiments described herein, and may be modified as necessary to meet specific requirements.

By providing the beams, the insertion and extraction force during mating can be increased when the electrical connector is engaged with a mating electrical connector, which enables a more stable assembly structure and reduces the risk of breakage of the beams. When the electrical connector engages with a mating electrical connector, the beam deforms elastically, which allows an appropriate insertion and extraction force, thereby ensuring reliability and stability of the electrical connector after the mating.

The present application further provides an exemplary method for manufacturing an electrical connector described herein. In some embodiments, the method for manufacturing an electrical connector may comprise providing a terminal subassembly 10 which is configured to comprise a plurality of conductive elements 110 and a subassembly housing 120 holding the conductive elements 110, each of the plurality of conductive elements 110 having a shape of an elongated strip. Each of the plurality of conductive elements 110 may comprise a mating end 111, a tail end 113 provided opposite to the mating end 111, and an intermediate portion 112 disposed between the mating end 111 and the tail end 113 and connecting the mating end 111 with the tail end 113; providing a shell 20 which is formed to have a cavity and sleeved on at least a portion of an outer side of the terminal subassembly 10; and providing a locating member 30 which is provided on at least a portion of an outer side of the shell 20 and comprising a post 301.

In some embodiments, conductive elements 110 may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

In some embodiments, providing a terminal subassembly 30 may comprise: providing a plurality of conductive elements 110; forming the plurality of conductive elements 110 into a first plurality of conductive elements 110A and a second plurality of conductive elements 110B, and arranging the first plurality of conductive elements 110A and the second plurality of conductive elements 110B in rows in a width direction X of the electrical connector 1, respectively, and arranging mating ends of the conductive elements of the first plurality of conductive elements 110A and the mating ends of the conductive elements of the second plurality of conductive elements 110B to be spaced apart from each other in a thickness direction Z of the electrical connector 1 perpendicular to the width direction X; providing a shielding member 130; and arranging the shielding member 130 between the first plurality of conductive elements 110A and the second plurality of conductive elements 110B in a manner that the shielding member 130 is parallel to and spaced apart from the mating ends of the first plurality of conductive elements 110A and the mating ends of the second plurality of conductive elements 110B, respectively.

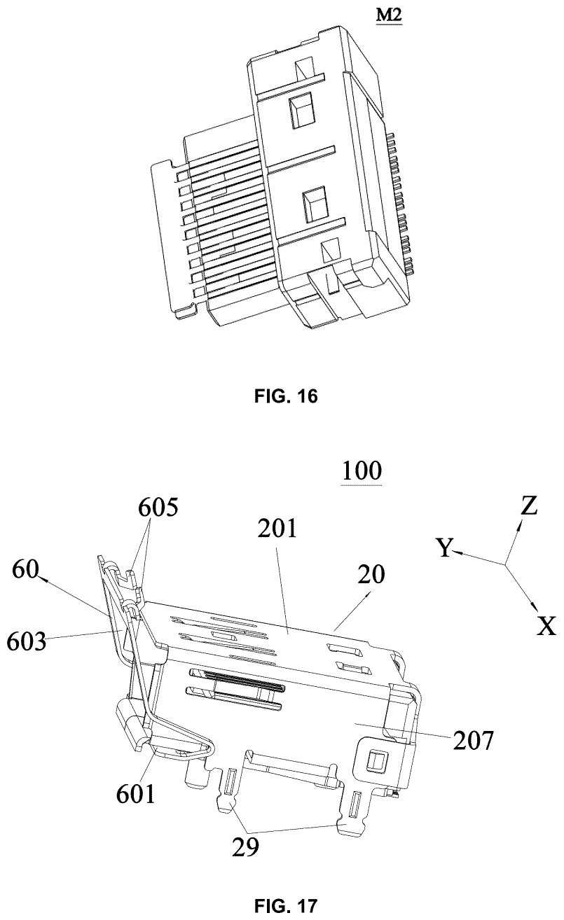

In some embodiments, providing the terminal subassembly 30 may further include: placing the second plurality of conductive elements 110B and the shielding member 130 in a first injection mold for a first injection molding to form a first molding member M1 (as shown in FIG. 15); and placing the first molding member M1 in a second injection mold, positioning the first plurality of conductive elements 110A in the first molding member M1 in a predetermined position, and performing a second injection molding to the first plurality of conductive elements 110A and the first molding member M1 to form a second molding member M2 (as shown in FIG. 16).

In some embodiments, providing the plurality of conductive elements 110 may comprise: stamping a metal sheet to form the first plurality of conductive elements 110A and the second plurality of conductive elements 110B; and providing the shielding member comprises: stamping a metal sheet to form the shielding member 130.

In some embodiments, providing the shielding member may comprise: forming, on the shielding member 130, a plurality of apertures each having a substantially rectangle shape, and comprising at least three rows of apertures arranged parallel to each other in the width direction X, the three rows of apertures comprises: a first row of apertures 131 arranged in the lengthwise direction Y of the electrical connector adjacent to the front end of the shielding member 130; a second row of apertures 132 arranged in the lengthwise direction Y of the electrical connector 1 adjacent to the rear end of the shielding member; and a third row of apertures 133 disposed between the first row of apertures 131 and the second row of apertures 132.

In some embodiments, forming the first molding member M1 may comprise: forming a plurality of channels 127 on the first molding member M1, the channels 127 extending in the thickness direction Z and being formed by at least a portion of the first row of apertures 131, the second row of apertures 132, and the third row of apertures 133 and the dielectric material. Forming the second molding member M2 comprises: filling the channels 127 formed in the first molding member M1 with the dielectric material. In some embodiments, the terminal subassembly 10 of the electrical connector 1 is formed by the second molding member M2.

As shown in FIG. 15, a plurality of through slots are provided on the insulating body portion of the first molding member M1, and part of the plurality of through slots are connected to the apertures on the shielding member 130 to form the channels 127. In the illustrated exemplary embodiment, the channels 127 provide a flow path for the molten dielectric material substantially in the thickness direction Z during the second injection molding. Using the two injection molding processes simplifies manufacturing and leads to time and cost savings. Further, it can reduce the voids within the terminal subassembly 10 of the electrical connector 1, which in turn can block contaminations such as water infiltration and improve product reliability.

In some embodiments, the dielectric material used in the first injection molding and the second injection molding processes may be an insulating material such as plastic or nylon. Examples of suitable materials include, but are not limited to, liquid crystal polymer (LCP), polyphenylene sulfide (PPS), high temperature nylon or polyphenylenoxide (PPO) or polypropylene (PP). Other suitable materials may be employed, as aspects of the present disclosure are not limited in this regard.

In some embodiments, providing the shell may comprise configuring the shell 20 to comprise a top wall 201, and a bottom wall 203 opposite to the top wall 201 in the thickness direction Z. The top wall 201 is provided with a flange 24 extending from a mating edge of the top wall 201 in the thickness direction Z towards an outer side of the electrical connector, the flange 24 being provided with a threaded hole.

In some embodiments, providing the locating member 30 may comprise: configuring the locating member 30 to comprise a board-shaped body 31, where the board-shaped body 31 comprises a first side 311 facing towards the bottom wall 203, and a second side 313 opposite to the first side 311 and provided with the post 301, and the post 301 extends from the second side 313 of the locating member 30 towards the outer side of the electrical connector and is formed integrally with the locating member 30, the locating member 30 further comprises a plurality of projections extending from the first side 311 towards the inner side of the shell 20, and the projections extend into the subassembly housing 120, so as to be secured in place in the subassembly housing 120.

In some embodiments, providing the shell may comprise: configuring the shell 20 to comprise a first sidewall 205 and a second sidewall 207 opposite to the first sidewall 205 in the width direction X, where a plurality of beams 220 are provided in at least one of the top wall 201, the bottom wall 203, the first sidewall 205 and the second sidewall 207.

In some embodiments, providing the shell may comprise: extending the beam 220 along a lengthwise direction Y of the shell 20 perpendicular to both the width direction X and the thickness direction Z, configuring the beam 220 to comprise a first angled portion 221, a second angled portion 222 and an curved portion 223 disposed between the first angled portion 221 and the second angled portion 222 and connecting the first angled portion with the second angled portion, the first angled portion and the second angled portion are each tilted inwardly with respect to the outer surface of the shell 20 and the curved portion 223 protrudes towards an inner side of the shell 20.

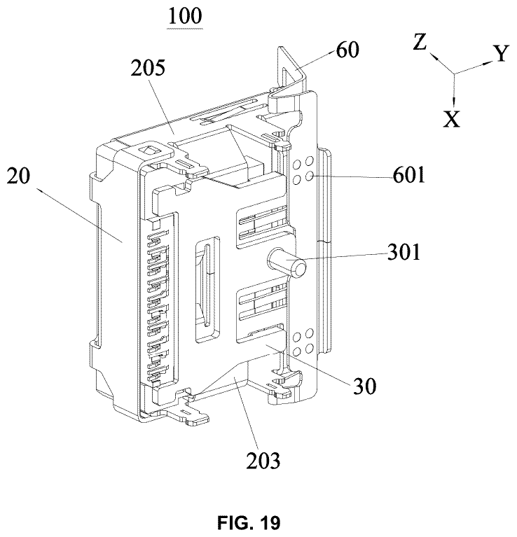

The electrical connector 100 according to another exemplary embodiment of the present application is described below with reference to FIGS. 17-21. As illustrated, the electrical connector 100 may share some features of the electrical connector 1 as described herein and the shared features may not be repeated.

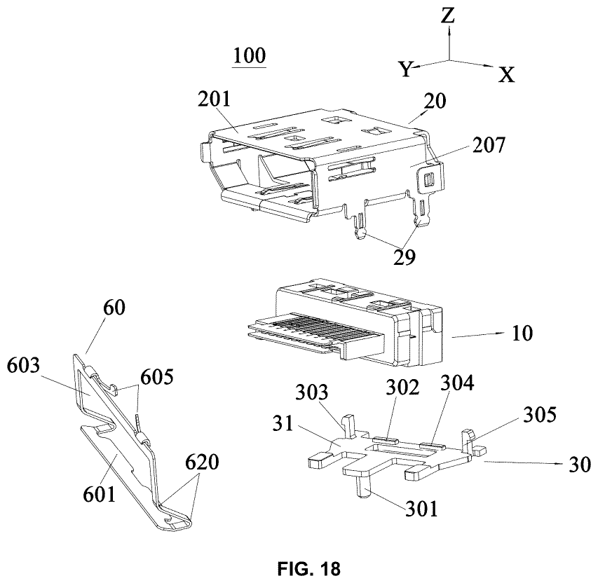

In the embodiment shown in FIG. 17 and FIG. 18, the shell 20 of the electrical connector 100 comprises: a top wall 201; a bottom wall 203 opposite to the top wall 201 in the thickness direction Z; a first sidewall 205; and a second sidewall 207 opposite to the first sidewall 205 in the width direction X. The shell 20 comprises a plurality of legs 29 extending downwardly in the thickness direction Z from the first sidewall 205 and the second sidewall 207. The plurality of legs 29 may be connected to a ground plane of the printed circuit board.

The electrical connector 100 comprises a spring shell 60 which comprises an opening 603, and an inner circumferential edge of the opening 603 is arranged at an outer side of the shell 20 of the electrical connector 100 in a projection plane of the electrical connector 100 perpendicular to the lengthwise direction Y. For example, at least a portion of the spring shell 60 may be sleeved on the outer wall of the shell 20 and do not obscure the mating portion of the electrical connector 100 that is mated with the mating electrical connector. In the illustrated embodiment, the open end of the shell 20 is not obscured by the spring shell 60.

The spring shell 60 comprises an extension 601 fixedly connected with the bottom wall 203 of the shell 20, and the extension 601 extends parallel to the bottom wall 203 of the shell 20. By fixedly connecting the extension 601 to the bottom wall 203, the spring shell 60 may be fixed to the shell 20 of the electrical connector 100, thereby ensuring a secure contact of the spring shell 60 with the shell 20. In some embodiments, the extension 601 of the spring shell 60 is connected to the shell 20 of the electrical connector 100 by laser welding.

The spring shell 60 comprises an elastic portion 605 configured to engage with the chassis 300 of the electronic device to be connected. When the spring shell 60 is assembled in the electrical connector 100, the elastic portion 605 is arranged adjacent to the top of the top wall 201 of the electrical connector 100. When the electrical connector 100 is mounted in the chassis 300 of the electronic device, the elastic portions 605 of the spring shell 60 are pressed to abut against the exterior of the chassis 300 of the electronic device and elastically deformed so that the spring shell 60 is electrically communicated to the chassis 300 of the electronic device.

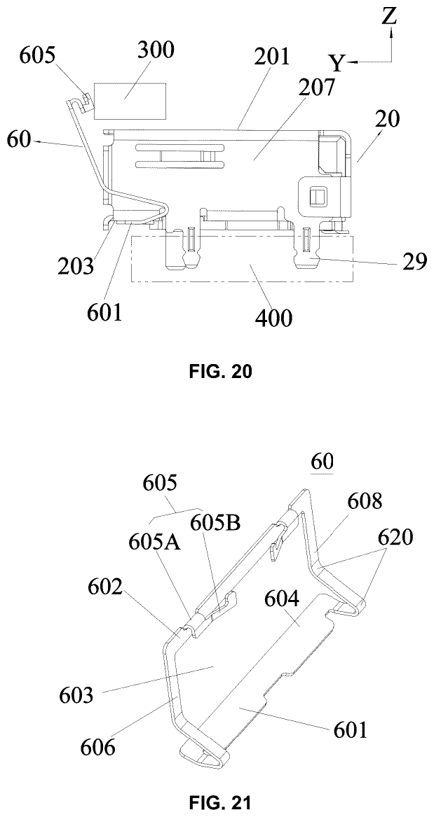

The shell 20 may be made of conductive materials (e.g., iron, aluminum, and alloys thereof). The spring shell 60 may also be made of a conductive material. Thereby, when the chassis 300 of the electronic device is made of metal, static electricity generated in the chassis 300 of the electronic device can be conducted through the spring shell 60, through the bottom wall 203 of the shell 20 of the electrical connector 100 and the leg 29 of the shell 20, and then to the ground portion of the printed circuit board (PCB) 400 which is connected to the leg 29 of the shell 20, thereby grounding the chassis 300 of the electronic device (as shown in FIG. 20). For example, a conduction path for the static electricity is formed among the chassis 300 of the electronic device, the shell 20 of the electrical connector 100, and the ground portion of the printed circuit board 400, so as to quickly and efficiently direct the static electricity generated in the chassis 300 of the electronic device to the ground portion of the printed circuit board 400 to prevent electrostatic discharge hazards and ensure operational safety.

In some embodiments, the spring shell 60 may be formed by performing a bending process on a plate preform having the opening 603. For example, the plate preform may have a substantially rectangular shape, and the spring shell 60 may be formed by performing bending twice on the plate preform having an opening 603.

In some embodiments, the spring shell 60 comprises a frame attached to the bottom wall 203 of the shell 20, and the frame includes a top bar 602 and a bottom bar 604 opposite to each other and a first side bar 606 and a second side bar 608 opposite to each other. The top bar 602 and the bottom bar 604 are arranged on the opposite sides of the shell 20 in the thickness direction Z. The first side bar 606 and the second side bar 608 each comprise a curved segment 620 and are arranged on the opposite sides of the shell 20 in the width direction X. The top bar 602 is provided with an elastic portion 605. The bottom bar 604 is provided with an extension 601 connected to a shell 20 of the electrical connector 100.

Optionally, as shown in FIG. 21, the first side bar 606 and the second side bar 608 may each comprise two curved segments 620. The tensile resistant strength and pressure resistant strength of the spring shell 60 can be improved by providing the curved segment, such that it is more durable and reliable.

Optionally, as shown in FIG. 21, the top bar 602 may be provided with two elastic portions 605, each of which comprises: a semi-cylindrical connecting portion 605A that is connected to an edge of the top bar 602 and extends from the edge of the top bar 602 toward a rear of the electrical connector 100; and an overhanging arm 605B that is connected to the semi-cylindrical connecting portion 605A and extends from the semi-cylindrical connecting portion 605A along a width direction X toward the center axis of the top bar 602 in the width direction X. When the spring shell 60 is assembled to the electrical connector 100, the semi-cylindrical connecting portion 605A of the elastic portion 605 is arranged such that the open side face of the semi-cylindrical connecting portion 605A faces the electrical connector 100. The free end of the overhanging arm 605B of the elastic portion 605 is configured to be matched to be engaged with the chassis 300 of the electronic device and apply a biasing force to the chassis 300 toward a rear of the electrical connector 100.

Accordingly, in some embodiments, a method of manufacturing an electrical connector may comprise providing a spring shell 60 having an opening 603, and sleeving the spring shell 60 on an outer side of the housing 20 of the electrical connector. Providing a spring shell 60 may comprise: configuring the spring shell 60 to comprise an extension 601 and an elastic portion 605, where the extension 601 is configured to extend parallel to the bottom wall 203 of the shell 20, and to be fixedly connected with the bottom wall 203 of the shell 20, and the elastic portion 605 is arranged adjacent to the top of the top wall 201 of the electrical connector 100.

Various aspects are described in this disclosure, which include, but may not be limited to, the following aspects:

1. An electrical connector (e.g., 1) comprising: a terminal subassembly (e.g., 10) including a plurality of conductive elements (e.g., 110) and a subassembly housing (e.g., 120) configured holding the plurality of conductive elements (e.g., 110), each of the plurality of conductive elements (e.g., 110) comprising a mating end (e.g., 111), a tail end (e.g., 113) opposite to the mating end, and an intermediate portion (e.g., 112) between the mating end (e.g., 111) and the tail end (e.g., 113) and connecting the mating end (e.g., 111) with the tail end (e.g., 113); a shell (e.g., 20) enclosing a cavity and sleeved on at least a portion of the outer side of the terminal subassembly (e.g., 10); and a locating member (e.g., 30) provided on at least a portion of the outer side of the shell (e.g., 20) and comprising a post (e.g., 301), wherein the plurality of conductive elements (e.g., 110) comprises a first plurality of conductive elements (e.g., 110A) and a second plurality of conductive elements (e.g., 110B), the first plurality of conductive elements (e.g., 110A) and the second plurality of conductive elements (e.g., 110B) are arranged in rows in a width direction (e.g., X) of the electrical connector (e.g., 1), respectively, and the mating ends of the conductive elements in the first plurality of conductive elements (e.g., 110A) and the mating ends of the conductive elements in the second plurality of conductive elements (e.g., 110B) are spaced apart from each other in a thickness direction (e.g., Z) of the electrical connector (e.g., 1) perpendicular to the width direction (e.g., X), and the terminal subassembly (e.g., 10) further comprises a shielding member (e.g., 130) disposed between the first plurality of conductive elements (e.g., 110A) and the second plurality of conductive elements (e.g., 110B) in the thickness direction (e.g., Z).

2. The electrical connector according to aspect 1 or other aspects, wherein the mating ends of the conductive elements in the first plurality of conductive elements (e.g., 110A) and the mating ends of the conductive elements in the second plurality of conductive elements (e.g., 110B) are arranged in a staggered manner in the width direction (e.g., X), and the tail ends of the conductive elements in the first plurality of conductive elements (e.g., 110A) and the tail ends of the conductive elements in the second plurality of conductive elements (e.g., 110B) are arranged in a same plane perpendicular to the thickness direction (e.g., Z) of the electrical connector (e.g., 1) and are arranged in a row in a staggered manner along the width direction (e.g., X).

3. The electrical connector according to aspect 2 or other aspects, wherein each conductive element in the first plurality of conductive elements (e.g., 110A) comprises one first bending portion (e.g., 115) configured in such a way that the tail end of the conductive element in the first plurality of conductive elements (e.g., 110A) extends towards the second plurality of conductive elements (e.g., 110B) in the thickness direction (e.g., Z), the first bending portions (e.g., 115) being arranged in a row and separated from each other in the width direction (e.g., X) of the electrical connector (e.g., 1); and each conductive element in the second plurality of conductive elements (e.g., 110B) comprises a first bending portion (e.g., 117) and a second bending portion (e.g., 119), the first bending portions (e.g., 117) and the second bending portions (e.g., 119) of the conductive elements in the second plurality of conductive elements (e.g., 110B) are respectively arranged in rows parallel to each other in the width direction (e.g., X) of the electrical connector (e.g., 1), and each conductive element in the second plurality of conductive elements (e.g., 110B) is configured, with the presence of the second bending portion (e.g., 119), such that the tail end of the conductive element in the second plurality of conductive elements (e.g., 110B) extends, in a staggered manner, between the tail ends of adjacent conductive elements in the first plurality of conductive elements (e.g., 110A).

4. The electrical connector according to aspect 3 or other aspects, wherein the shielding member (e.g., 130) is plate shaped, the shielding member (e.g., 130) is provided in the thickness direction (e.g., Z) between the mating ends of the conductive elements of the first plurality of conductive elements (e.g., 110A) and the mating ends of the conductive elements of the second plurality of conductive elements (e.g., 110B), and a rear end of the shielding member (e.g., 130) is provided in a lengthwise direction (e.g., Y) perpendicular to the width direction (e.g., X) to be extended beyond the first bending portion (e.g., 117) of the second plurality of conductive elements (e.g., 110B) and be spaced apart from the first bending portion (e.g., 115) of the first plurality of conductive elements (e.g., 110A).

5. The electrical connector according to aspect 4 or other aspects, wherein the conductive elements in the first plurality of conductive elements (e.g., 110A) and the conductive elements in the second plurality of conductive elements (e.g., 110B) respectively comprise a plurality of signal terminals and a plurality of ground terminals, wherein the mating ends of the ground terminals are arranged to be extended beyond the mating ends of the signal terminals in a mating direction along which the electrical connector is engaged with a mating electrical connector.

6. The electrical connector according to aspect 5 or other aspects, wherein the plurality of signal terminals comprise at least one signal terminal (e.g., 1101), the intermediate portion of the signal terminal (e.g., 1101) comprising a narrow portion (e.g., 1101A), the narrow portion having a first width in the width direction (e.g., X) of the electrical connector, a mating end of the signal terminal having a second width in the width direction (e.g., X) of the electrical connector, and the first width less than the second width.

7. The electrical connector according to aspect 6 or other aspects, wherein the plurality of ground terminals comprise at least one ground terminal (e.g., 1103), the intermediate portion of the ground terminal (e.g., 1103) comprising a wide portion (e.g., 1103A), the wide portion having a third width in the width direction (e.g., X) of the electrical connector, a mating end of the ground terminal (e.g., 1103) having a fourth width in the width direction (e.g., X) of the electrical connector, and the third width greater than the fourth width.

8. The electrical connector according to aspect 7 or other aspects, wherein the wide portion of the ground terminal in the first plurality of conductive elements (e.g., 110A) comprises the first bending portion (e.g., 115), and the wide portion of the ground terminal in the second plurality of conductive elements (e.g., 110B) comprises the first and second bending portions (e.g., 117, 119).

9. The electrical connector according to aspect 7 or other aspects, wherein the shielding member (e.g., 130) comprises a plurality of apertures each having a substantially rectangle shape, and comprises at least three rows of apertures arranged parallel to each other in the width direction (e.g., X), the three rows of apertures comprising: a first row of apertures (e.g., 131) arranged adjacent to the front end of the shielding member (e.g., 130) in the lengthwise direction (e.g., Y) of the electrical connector; a second row of apertures (e.g., 132) arranged adjacent to the rear end of the shielding member in the lengthwise direction (e.g., Y) of the electrical connector (e.g., 1); and a third row of apertures (e.g., 133) disposed between the first row of apertures (e.g., 131) and the second row of apertures (e.g., 132).

10. The electrical connector according to aspect 9 or other aspects, wherein the first row of apertures (e.g., 131) is provided in the thickness direction (e.g., Z) directly below mating ends of the plurality of signal terminals in the first plurality of conductive elements (e.g., 110A); and at least part of the apertures of the second row of apertures (e.g., 132) are provided in the thickness direction (e.g., Z) directly below at least a portion of the wide portion (e.g., 1103A) of the ground terminal (e.g., 1103) in the first plurality of conductive elements (e.g., 110A); and at least other part of the apertures of the second row of apertures (e.g., 132) are provided in the thickness direction (e.g., Z) directly below at least a portion of the narrow portion (e.g., 1101A) of the signal terminal (e.g., 1101) in the first plurality of conductive elements (e.g., 110A), wherein at least a portion of the subassembly housing (e.g., 120) is provided in a void formed among the first plurality of conductive elements (e.g., 110A), the plurality of apertures of the shielding member (e.g., 130), and the second plurality of conductive elements (e.g., 110B).

11. The electrical connector according to aspect 10 or other aspects, wherein each aperture in the first row of apertures (e.g., 131) is formed to have a substantially rectangular shape, each aperture in the first row of apertures (e.g., 131) has a width greater than a width of a mating end of the plurality of signal terminals, and a mating inner edge of each aperture in the first row of apertures (e.g., 131) is arranged to be closer to a mating peripheral portion of the shell (e.g., 20) than the mating end of the plurality of signal terminals in the lengthwise direction (e.g., Y).

12. The electrical connector according to any one of aspects 1 to 11 or other aspects, wherein the shell (e.g., 20) comprises: a top wall (e.g., 201); a bottom wall (e.g., 203) opposite to the top wall (e.g., 201) in the thickness direction (e.g., Z); a first sidewall (e.g., 205); and a second sidewall (e.g., 207) opposite to the first sidewall (e.g., 205) in the width direction (e.g., X).

13. The electrical connector according to aspect 12 or other aspects, wherein the top wall (e.g., 201) is provided with a flange (e.g., 24) extending from a mating edge of the top wall (e.g., 201) towards the outer side of the electrical connector in the thickness direction (e.g., Z), the flange (e.g., 24) being provided with a threaded hole.

14. The electrical connector according to aspect 12 or other aspects, wherein the bottom wall (e.g., 203) comprises an opening through which at least a portion of the subassembly housing (e.g., 120) and the tail ends of the plurality of conductive elements (e.g., 110) are exposed, the locating member (e.g., 30) comprises a board-shaped body (e.g., 31) arranged to be extended over at least a portion of an outer surface of the bottom wall (e.g., 203) of the shell (e.g., 20) and a portion of the subassembly housing (e.g., 120) exposed by the opening, and the board-shaped body (e.g., 31) comprises a first side (e.g., 311) facing the bottom wall (e.g., 203), and a second side (e.g., 313) opposite to the first side (e.g., 311) and provided with the post (e.g., 301), the post (e.g., 301) extends from the second side (e.g., 313) of the locating member (e.g., 30) towards the outer side of the electrical connector and is formed integrally with the locating member (e.g., 30), the locating member (e.g., 30) further comprises a plurality of projections extending from the first side (e.g., 311) towards the inner side of the shell (e.g., 20), the projections extend into the subassembly housing (e.g., 120) via the opening of the bottom wall (e.g., 203), so as to be secured in place in the subassembly housing (e.g., 120).

15. The electrical connector according to aspect 14 or other aspects, wherein the plurality of projections comprise a first projection (e.g., 303) and a second projection (e.g., 305) extending towards the subassembly housing (e.g., 120) in a manner parallel to each other in the thickness direction (e.g., Z) and on the opposite sides of the locating member (e.g., 30) in the width direction (e.g., X), and the post (e.g., 301) is arranged at a substantially central position of the locating member (e.g., 30) in the width direction (e.g., X).

16. The electrical connector according to aspect 15 or other aspects, wherein the first projection (e.g., 303) and the second projection (e.g., 305) are each formed as an elongated cantilever beam having a free end with a latch (e.g., 309), and the subassembly housing (e.g., 120) comprises a protrusion (e.g., 122) mating with the latch (e.g., 309) in a snap-fit manner.

17. The electrical connector according to aspect 16 or other aspects, wherein the latch (e.g., 309) comprises a protrusion protruding from the free end of the elongated cantilever beam towards the first sidewall (e.g., 205) or the second sidewall (e.g., 207), and the protrusion (e.g., 122) comprises a concave accommodating part mating with the protrusion.

18. The electrical connector according to aspect 12 or other aspects, wherein a plurality of beams are provided in at least one of the top wall (e.g., 201), the bottom wall (e.g., 203), the first sidewall (e.g., 205) and the second sidewall (e.g., 207).

19. The electrical connector according to aspect 18 or other aspects, wherein the beam (e.g., 220) extends along a lengthwise direction (e.g., Y) of the shell (e.g., 20) perpendicular to both the width direction (e.g., X) and the thickness direction (e.g., Z), the beam (e.g., 220) comprises a first angled portion (e.g., 221), a second angled portion (e.g., 222) and an curved portion (e.g., 223) disposed between the first angled portion and the second angled portion and connecting the first angled portion with the second angled portion, the first angled portion and the second angled portion are each tilted inwardly with respect to the outer surface of the shell (e.g., 20) and the curved portion protrudes towards the inner side of the shell (e.g., 20).

20. The electrical connector according to aspect 19 or other aspects, wherein the plurality of beams comprise a first row of beams provided in the top wall (e.g., 201) and a second row of beams provided in the bottom wall (e.g., 203), and the first row of beams and the second row of beams are symmetrical with respect to a plan that runs through a horizontal central axis along the width direction (e.g., X).

21. The electrical connector according to aspect 12 or other aspects, wherein the electrical connector comprises a spring shell (e.g., 60) having an opening (e.g., 603), and in a projection plane of the electrical connector perpendicular to the lengthwise direction (e.g., Y), an inner circumferential edge of the opening (e.g., 603) is arranged at the outer side of the shell (e.g., 20) of the electrical connector, the spring shell (e.g., 60) comprises an extension (e.g., 601) fixedly connected with the bottom wall (e.g., 203) of the shell (e.g., 20) and extending parallel to the bottom wall (e.g., 203) of the shell (e.g., 20), and an elastic portion (e.g., 605) arranged adjacent to the top of the top wall (e.g., 201) of the electrical connector.

22. The electrical connector according to aspect 21 or other aspects, wherein the spring shell (e.g., 60) comprises a frame comprising: a top bar (e.g., 602) and a bottom bar (e.g., 604) opposite to each other, and a first side bar (e.g., 606) and a second side bar (e.g., 608) opposite to each other, the top bar (e.g., 602) and the bottom bar (e.g., 604) are arranged on the opposite sides of the shell (e.g., 20) in the thickness direction (e.g., Z), the first side bar (e.g., 606) and the second side bar (e.g., 608) respectively comprise a curved segment and are arranged on the opposite sides of the shell (e.g., 20) in the width direction (e.g., X), the elastic portion (e.g., 605) is provided on the top bar (e.g., 602) and the extension (e.g., 601) is provided on the bottom bar (e.g., 604).

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, in some embodiments, the aspects of the present disclosure may not be limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. In some embodiments, the spatial relative terms not only include the orientations of the components shown in the accompanying drawings, but also include different orientations in use or operation.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (e.g. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. In some embodiments, various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector configured for use in an electronic device, the receptacle connector comprising:
a shell comprising a top wall, bottom wall, first sidewall and second sidewall, bounding a cavity, an opening at a front and connected to the cavity, and a plurality of legs extending beyond the bottom wall;
a terminal subassembly at least partially disposed in the cavity, the terminal subassembly comprising a subassembly housing and a plurality of conductive elements held by the subassembly housing, each of the plurality of conductive elements comprising a mating end extending toward the front of the shell, a tail end extending out of the bottom wall of the shell, and an intermediate portion between the mating end and the tail end;
a locating member comprising a post extending parallel to the plurality of legs of the shell; and
a component at least partially adjacent the top wall of the shell and configured to engage an exterior of a chassis of the electronic device.

2. The receptacle connector of claim 1, wherein:
the component is a flange extending from the top wall of the shell; and
the flange comprises a threaded hole such that the flange can be secured to the exterior of the chassis of the electronic device.

3. The receptacle connector of claim 1, wherein:
the component is a frame comprising a top bar, a bottom bar, and an extension extending from the bottom bar and fixedly attached to the bottom wall of the shell; and
the frame comprises an elastic portion extending from the top bar and configured for engaging the exterior of the chassis of the electronic device.

4. The receptacle connector of claim 3, wherein the frame comprises:
an opening aligned with the opening of the shell; and
first and second side bars each connecting the top bar and the bottom bar from respective sides and comprising a curved segment adjacent to the bottom bar.

5. The receptacle connector of claim 3, wherein the elastic portion comprises:
a semi-cylindrical connecting portion extending from the top bar; and
an overhanging arm extending from the semi-cylindrical connecting portion.

6. The receptacle connector of claim 1, wherein:
the plurality of conductive elements of the terminal subassembly comprises a first plurality of conductive elements disposed in a first row, and a second plurality of conductive elements disposed in a second row;
the terminal subassembly comprises a shielding member disposed between the first plurality of conductive elements and the second plurality of conductive elements and comprising a plurality of apertures; and
the subassembly housing extends through apertures of the plurality of apertures.

7. The receptacle connector of claim 6, wherein:
mounting surfaces of the tail ends of the first plurality of conductive elements and mounting surfaces of the tail ends of the second plurality of conductive elements are aligned in a same row.

8. The receptacle connector of claim 6, wherein:
the first plurality of conductive elements comprises a plurality of signal terminals and a plurality of ground terminals;
the mating ends of the plurality of ground terminals extend beyond the mating ends of the plurality of signal terminals;
the intermediate portions of the plurality of signal terminals each comprises a narrow portion narrower than the respective mating end; and
the intermediate portion of the plurality of ground terminals each comprises a wide portion wider than the respective mating end.

9. The receptacle connector of claim 8, wherein the plurality of apertures of the shielding member comprises:
a first row of apertures disposed adjacent to a front end of the shielding member and below the mating ends of the plurality of signal terminals of the first plurality of conductive elements;
a second row of apertures disposed adjacent to a rear end of the shielding member and below at least a portion of the wide portions of the plurality of ground terminals of the first plurality of conductive elements; and
a third row of apertures disposed between the first row of apertures and the second row of apertures and below at least a portion of the narrow portions of the plurality of signal terminals of the first plurality of conductive elements.

10. The receptacle connector of claim 1, wherein:
the locating member comprises a body attached to the bottom wall of the shell; and
the post extends from the body downwardly.

11. The receptacle connector of claim 10, wherein:
the locating member comprises a projection extending upwardly; and
the projection of the locating member comprises a latch configured to engage a protrusion of the subassembly housing.

12. An electronic system comprising:
a chassis comprising a port;
a circuit board disposed in the chassis; and
a receptacle connector disposed in the chassis and mounted on the circuit board, the receptacle connector comprising:
a shell comprising an opening aligned with the port of the chassis, and a plurality of legs connected to a ground plane of the circuit board, and
a locating member comprising a post at least partially inserted into the circuit board.

13. The electronic system of claim 12, wherein the receptacle connector comprises:
a component extending out of the port of the chassis to engage an exterior of the chassis.

14. The electronic system of claim 13, wherein:
the shell of the receptacle connector comprises a top wall and a bottom wall; and
the component is a flange extending from the top wall of the shell.

15. The electronic system of claim 13, wherein:
the shell of the receptacle connector comprises a top wall and a bottom wall; and
the component is a frame comprising a top bar disposed outside the chassis, a bottom bar, and an extension extending from the bottom bar and fixedly attached to the bottom wall of the shell of the receptacle connector, and an elastic portion extending from the top bar.

16. The electronic system of claim 15, wherein the elastic portion comprises:
a semi-cylindrical connecting portion extending from the top bar; and
an overhanging arm extending from the semi-cylindrical connecting portion and engaging the exterior of the chassis.

17. The electronic system of claim 13, wherein:
the shell of the receptacle connector comprises a top wall and a bottom wall; and
the locating member comprises:
a body attached to the bottom wall of the shell; and
a projection extending into the shell of the receptacle connector and comprising a latch configured for engaging a connector housing.

18. A method of manufacturing a receptacle connector, comprising:
providing a terminal subassembly comprising a plurality of conductive elements held by a subassembly housing;
disposing the terminal subassembly in a shell, with tail ends of the plurality of conductive elements extending out of the shell, the shell comprising a bottom wall and a plurality of legs extending beyond the bottom wall; and
attaching a locating member to the bottom wall of the shell, the locating member comprising a post extending parallel to the plurality of legs of the shell.

19. The method of claim 18, wherein providing the terminal subassembly comprises:
molding over a first row of the plurality of conductive elements and a shielding member;
disposing a second row of the plurality of conductive elements on the molded first row and shielding member; and
molding over the first and second rows of conductive elements and the shielding member to form the subassembly housing.

20. The method of claim 18, wherein attaching the locating member to the bottom wall of the shell comprises:
inserting projections of the locating member into the shell to engage the subassembly housing of the terminal subassembly.
